(19) United States
(12) Patent Application Publication
(10) Pub. No.: US 2015/0310011 A1
(43) Pub. Date: Oct. 29, 2015

(54) SYSTEMS AND METHODS FOR PROCESSING TEXTUAL INFORMATION TO IDENTIFY AND/OR NAME INDIVIDUAL DIGITAL TRACKS OR GROUPS OF DIGITAL TRACKS

(71) Applicant: Evergig Music S.A.S.U., Paris (FR)

(72) Inventors: Cyril Poulet, Paris (FR); Nicolas Lapomarda, Paris (FR); Florent Vouin, Paris (FR)

(21) Appl. No.: 14/699,178

(22) Filed: Apr. 29, 2015

Related U.S. Application Data
(60) Provisional application No. 61/985,705, filed on Apr. 29, 2014.

(51) Int. Cl. G06F 17/30

(52) U.S. Cl. CPC G06F 17/30038; G06F 17/30601; G06F 17/30026

(57) ABSTRACT

Systems and methods identify and/or label one or more digital multimedia tracks recorded at a same first event performed by a same artist. The systems and methods comprise accessing sample digital multimedia files that are storable in a database, wherein the sample digital multimedia files are original recorded digital videos that were recorded from multiple digital sources at the same first event, wherein the sample digital multimedia files have metadata comprising video titles associated with the sample digital multimedia files. The systems and methods may match the video titles of at least a portion of the sample digital multimedia files with at least one song name associated with the same artist to provide one or more first matchings and match at least a portion of the sample digital multimedia files with one or more groups of digital audio tracks associated with the same artist or one or more studio recordings by the same artist to provide one or more second matchings. The systems and methods may merge the first and second matchings into a single output that is labeled with one or more song names associated with the same artist and group at least a portion of the sample digital multimedia files together to form a multi-angle video of at least a portion of the same event.

### CROSS REFERENCE TO RELATED APPLICATION

This application is a non-provisional application claiming the benefit under 35 U.S.C. 119(e) of U.S. Provisional Patent Application No. 61/985,705, filed on Apr. 29, 2014, which is incorporated herein by reference in its entirety.

### FIELD OF DISCLOSURE

The present systems and methods process textual information identify individual digital tracks or groups of digital tracks and/or names digital tracks or groups of digital tracks. The present systems and methods are configured or adapted to process textual information of at least one group of recorded and synchronized digital audio and/or video tracks to identify or name individual songs or groups of songs contained within the group of recorded and synchronized audio and/or video tracks. The group of recorded and synchronized digital audio and/or video tracks is recorded digital audio and/or video tracks of an entire concert or a portion of said concert that previously occurred. Since the audio and/or video tracks have been previously synchronized, the precise or exact location of the audio and/or video tracks on a timeline of the entire concert is known, determined and/or identified by the present systems and methods. Moreover, the timeline refers to a time indication about a start of a song and/or an end of a song.

The present systems and methods extract one or more song names of an artist that performed during said concert from the recorded and synchronized audio tracks to classify corresponding recorded and/or synchronized video tracks. The present systems and methods utilize a list of video titles and/or a list of songs, such as, for example, a setlist of an artist or all songs from said artist, if the setlist is not known or available, to determine if the recorded and synchronized audio tracks contains the one or more song names of the artist that performed during said concert. If a song pattern of the recorded and synchronized audio tracks contains the one or more song names of the artist that performed during said concert, then the corresponding recorded and synchronized video tracks are classified by the present systems and methods as containing the one or more song names of the artist. The present systems and methods may utilize a dictionary and/or a matrix and/or may execute or run a Non-Negative Matrix Factorization (hereinafter “NMF”) to determine if the one or more song names is present or contained within the audio tracks.

The inventive systems and methods are configured or adapted to verify a setlist of songs performed by the artist at the concert. The group of recorded and synchronized audio and/or video tracks provides an entire timeline, or a partial timeline, of the concert performed by the artist. The present systems and methods are configured or adapted to process the group of recorded and synchronized audio and/or video tracks, determine if the setlist or entire timeline, or partial timeline, contains one or more errors, and, if an error is detected, remove the error from the setlist or the timeline. When no setlist of the concert is known or available, then the present systems and methods are configured or adapted to extract an accurate setlist and/or a consistent sub-timeline from the recorded and synchronized audio tracks.

The present systems and methods implement and/or execute one or more computer-implemented steps or instructions, computer algorithms and/or computer software to process textual information and/or song patterns associated with the recorded and synchronized audio tracks. As a result, the present systems and methods extract one or more song names from recorded and synchronized audio tracks, identify one or more songs or groups of songs contained within the recorded and synchronized audio tracks, and/or verify if any errors are present in a setlist or the timeline of the concert associated with the audio tracks. By executing the one or more computer-implemented steps or instructions, computer algorithms and/or computer software, the present systems and methods may verify accuracy of a setlist or a timeline of the concert, detect or identify one or more errors in the setlist or timeline of the concert, and/or remove the one or more errors from the setlist or timeline of the concert. Moreover, by executing the one or more computer-implemented steps or instructions, computer algorithms and/or computer software, the present system and methods may extract an accurate setlist and/or a consistent sub-timeline of the concert from the recorded and synchronized audio tracks when the setlist of the concert is not known or available. For example, the present systems and methods may extract an accurate setlist and/or a consistent sub-timeline of the concert from the recorded and synchronized audio tracks via, for example, a most probable group order algorithm, a time-based tree algorithm, a time-based heuristic tree algorithm, time-based accelerated tree algorithm, a time-based heuristic accelerated tree algorithm and/or a time-based linear programming algorithm.

### SUMMARY OF THE DISCLOSURE

In embodiments, systems and method identify and/or label one or more digital multimedia tracks recorded at a same first event performed by a same artist. The systems and methods may access sample digital multimedia files that are storable in a database, wherein the sample digital multimedia files are original recorded digital videos that were recorded from multiple digital sources at the same first event, wherein the sample digital multimedia files have metadata comprising video titles associated with the sample digital multimedia files, match the video titles of at least a portion of the sample digital multimedia files with at least one song name associated with the same artist to provide one or more first matchings, match at least a portion of the sample digital multimedia files with (i) one or more groups of digital audio tracks associated with the same artist or (ii) one or more studio recordings by the same artist to provide one or more second matchings, and merge the first and second matchings into a single output that is labeled with one or more song names associated with the same artist.

In an embodiment, the single output may comprise a song list of at least a portion of the same first event performed by the same artist.

In an embodiment, the systems and methods may group at least a portion of the sample digital multimedia files together to form a multi-angle video of at least a portion of the same event.

In an embodiment, the systems and methods may label a group of digital video files recorded at a second event with one or more song names associated with the same artist or one or more different artists.

In an embodiment, the systems and methods may add new data associated with the same artist to a database as the new data becomes available and/or label a group of digital video files associated with the same artist based on the new data.

In an embodiment, the new data may comprise a setlist of the same first event.

In an embodiment, the systems and methods may add one or more groups of digital video files to a database, wherein the digital video files were recorded a plurality of events performed by the same artist and/or label the one or more groups of digital video files with one or more song names associated with the same artist.

In an embodiment, the systems and methods may add at least one new studio recording by the same artist to a database and/or label a group of digital video files based on the at least one new studio recording.

In an embodiment, the single output may comprise a list of matching song names.

In an embodiment, the systems and methods may access a website application programming interface to update song names of at least one group of digital video files stored in a database.

In an embodiment, the second matchings may be based on at least one selected from first digital fingerprints of the one or more groups of digital audio tracks associated with the same artist and second digital fingerprints of the one or more studio recordings by the same artist.

In an embodiment, a text algorithm may provide the first matchings and an audio algorithm may provide the second matchings.

### BRIEF DESCRIPTION OF THE DRAWINGS

So that the above recited features and advantages of the present systems and methods can be understood in detail, a more particular description of the present systems and methods, briefly summarized above, may be had by reference to the embodiments thereof that are illustrated in the appended drawings. It is to be noted, however, that the appended drawing illustrates only typical embodiments of this invention and are therefore not to be considered limiting of its scope, for the invention may admit to other equally effective embodiments.

FIG. 1 illustrates a block diagram of a computer system for processing textual information to identify individual digital tracks or groups of digital tracks and/or to name individual digital tracks or groups of digital tracks in an embodiment.

FIGS. 2A and 2B illustrate results for the graph clustering algorithm on an artist dataset, wherein the graph shown in FIG. 2A is before clustering and the graph shown in FIG. 2B is after clustering.

### DETAILED DESCRIPTION OF THE DISCLOSURE

The present systems and/or methods comprise techniques and/or tools for processing, and/or identifying textual information of one or more recorded and synchronized digital audio tracks and/or naming one or more tracks of the recorded and synchronized digital audio tracks that were recorded by multiple digital sources. The digital audio tracks may be previously recorded digital audio tracks recorded by at least two digital mobile devices. The techniques and/or tools utilized by the present systems and/or methods may be in the form of at least one selected from computer-implemented steps or instructions, computer algorithms and/or computer software that process textual information of digital tracks and/or groups of digital tracks to name one or more digital tracks when executed by one or more microprocessors associated with the present system and/or methods.

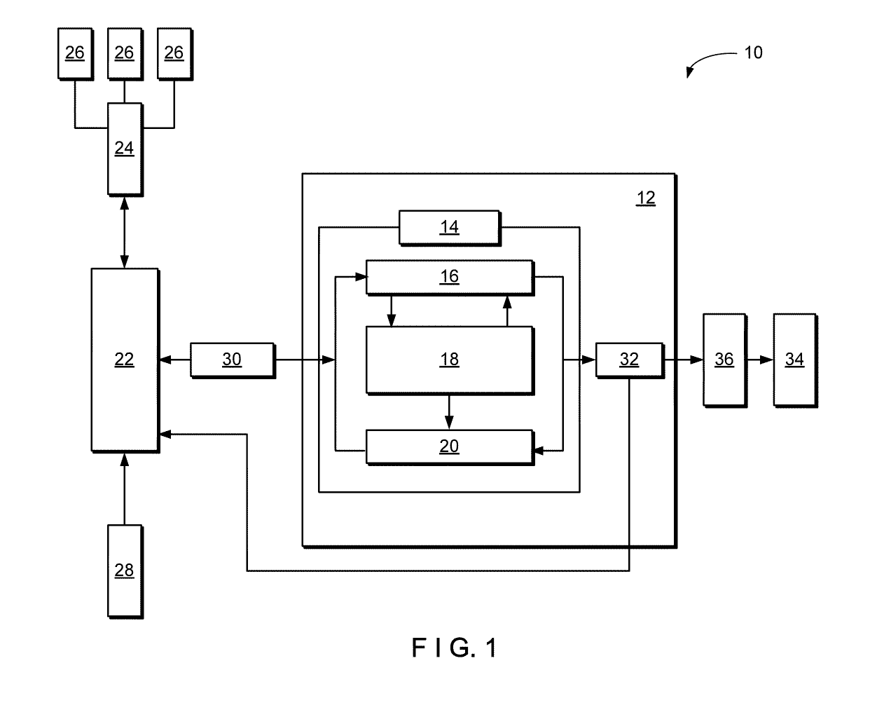

Referring now to the drawings wherein like numerals refer to like parts, FIG. 1 shows a computer system 10 (hereinafter “system 10”) configured and/or adapted for processing textual information to identify and/or name individual digital tracks or groups of digital tracks.

The system 10 comprises at least one computer 12 (hereinafter “computer 12”) which comprises at least one central processing unit 14 (hereinafter “CPU 14”) having at least one control unit 16 (hereinafter “CU 16”), at least one arithmetic logic unit 18 (hereinafter “ALU 18”) and at least one memory unit (hereinafter “MU 20”). One or more communication links and/or connections, illustrated by the arrowed lines within the CPU 14, allow or facilitate communication between the CU 16, ALU 18 and MU 20 of the CPU 14. One or more computer-implemented steps or instructions, computer algorithms and/or computer software (hereinafter “software”) for processing textual information to identify or name individual tracks, or groups of tracks, assigning one or more track or song names to one or more parts of at least one recorded and synchronized digital audio and video track is uploaded and stored on a non-transitory storage medium (not shown in the drawings) associated with the MU 20 of the CPU 14. The one or more computer software may comprise, for example, a most probable group order algorithm, a time-based tree algorithm, a time-based heuristic tree algorithm, time-based accelerated tree algorithm, a time-based heuristic accelerated tree algorithm and/or a time-based linear programming algorithm.

The system 10 may further comprise a database server 22 (hereinafter “server 22”) and a database 24 which may be local or remote with respect to the computer 12. The computer 12 may be connected to and/or in digital communication with the server 22 and/or the database 24, as illustrated by the arrowed lines extending between the computer 12 and the server 22 and between the server 22 and the database 24. In an embodiment not shown in the drawings, the server 22 may be excluded from the system 10 and the computer 12 may be directly connected to and in direct digital communication with the database 24. A plurality of digital media files and/or data files 26 (hereinafter “data files 26”) are stored within the database 24 which are accessible by and transferable to the computer 12 via the server 22 or via a direct communication link (not shown in the drawings) between the computer 12 and the database 24 when the server 22 is excluded from the system 10.

The data files 26 stored in the database 24 comprise digital audio files, digital video files and/or digital multimedia files. The digital audio files comprise digital audio tracks, the digital video files comprise digital video tracks, and the digital audio and video tracks are recorded audio and video tracks of one or more portions of the same event, such as, for example, a musical concert that previously occurred. The one or more portions of the same event may be one or more durations of time that occurred between the beginning and the end of the same event. In embodiments, when the data files 26 are digital multimedia files, the digital multimedia files contain a combination of different content forms, such as, for example, recorded digital audio and video tracks. The digital audio and video tracks of the data files 26 are the original recorded audio and video signals recorded during the same event by the at least two different users via different digital mobile devices (i.e., from multiple sources). In embodiments, original recorded audio and video signals from multiple sources may have been uploaded, transferred to or transmitted to the system 10 via at least one digital input device 28 which may be connectible to the system 10 by a communication link or interface as illustrated by the arrowed line in FIG. 1 between server 22 and input device 28. In embodiments, the digital input device 28 may be an augmented reality device, a computer, a digital audio recorder, a digital camera, a handheld computing device, a laptop computer, a mobile computer, a notebook computer, a smart device, a tablet computer or a wearable computer. The present disclosure should not be deemed as limited to a specific embodiment of multimedia files and/or the input device 28.

In embodiments, the data files 26 that are stored in the database 24 may comprise one or more, or a group of, recorded and synchronized audio and/or video tracks which have been previously synchronized, via an audio-synch algorithm, such that their precise exact time location within the timeline of the entire concert is known, identified and determined. The CPU 14 may access the one or more, or a group of, recorded and synchronized input audio tracks 30 (hereinafter “input audio tracks 30” or “input 30”) which may be stored in and/or accessible from the database 24. In an embodiment, the CPU 14 may select the input audio tracks 30 from the data files 26 stored in the database 24. The CPU 14 may transmit a request for accessing the input audio tracks 30 to the server 22, and the server 22 may execute the request and transfer the input audio tracks 30 to the CPU 14 of the computer 12. The CPU 14 of the computer 12 may execute or initiate the software stored on the non-transitory storage medium of MU 20 to perform, execute and/or complete one or more computer-implemented instructions, actions and/or steps associated the present methods of the present invention. Upon execution, activation and/or completion of the software, the CPU 14 may generate, produce, calculate or compute an output 32 which may be dependent of the specific inventive method being performed by the CPU 14 or computer 12.

For example, the systems 10 may, upon execution of the software, process textual information of the input audio tracks 30 and identify and/or name individual digital tracks or groups of digital tracks contained within the input audio tracks 30. As a result, the output 32 may be, or may include, identification and/or naming of one or more individual tracks or groups of tracks that may be contained within the input audio tracks 30. In embodiment, the system 10 may, upon execution of the software, extract one or more song names of an artist that performed during the same event from the input audio tracks 30 to classify the corresponding recorded and synchronized video tracks. As a result, the output 32 may be the one or more extracted song names or one or more classified corresponding video tracks. In an embodiment, the system 10 may utilize a list of video titles, a list of songs, such as, for example, a setlist of an artist or all songs from the artist, if the setlist is not known or available, to determine, upon execution of the software, if the input audio tracks 30 contains the one or more song names and extract one or more contained song names. As a result, the output 32 may be one or more extracted and contained song names. In an embodiment, the system 10 utilizes a dictionary, a matrix and/or may execute or run a Non-Negative Matrix Factorization (hereinafter “NMF”) to determine if the one or more song names are present or contained within the input audio tracks 30. As a result, the output 32 may be one or more present or contained song names.

In an embodiment, the system 10 may, upon execution of the software, verify a setlist of songs performed by the artist at the same event, or a portion of the same event, based on the input audio tracks 30, process the input audio tracks 30, determine if the setlist of entire timeline, or partial timeline, contains one or more errors, and, if an error is detected, remove the error from the setlist or timeline. As a result, the output 32 may be verification of the setlist of performed songs, one or more errors contained within the setlist, the entire timeline or the partial timeline, and/or a removal instruction to remove the one or more errors from the setlist and/or timeline. If no setlist of the concert is known, provided or available, then the system 10 may, upon execution of the software, extract an accurate setlist and/or a consistent sub-timeline from the input audio tracks 30. As a result, the output 32 may be an extracted accurate setlist and/or an extracted consistent sub-timeline. In embodiments, the output 32 may include probable start and end times of each song in the setlist.

Additional computer-implemented instructions, actions or steps that are performable or executable by the CPU 14 and software are subsequently discussed with respect to the inventive method s disclosure herein. Upon execution of the software by the CPU 14, the system 10 may perform, complete or execute one or more of the inventive methods disclosed hereinafter by performing, completing or executing the additional computer-implemented instructions, actions or steps disclosed herein.

After the output 32 is created by the CPU 12, the output 32 may be transferred or transmitted to the server 22 which may store the output 32. Alternatively, the output 32 may be transferred to a memory 34 associated with the computer 12 via communication link 36 that may connect the CPU 14 and the memory 34 such that the CPU 14 may be in communication with the memory 34. The memory 34 may be local or remote with respect to the computer 12. In embodiments, the computer 12, the server 22, the database 24 and/or the memory 34 may be connected and/or in communication with one another via a digital communication network (not shown in the drawings) which may be a wireless network, a wired communication network or combination thereof. The digital communication network may be any digital communication network as known to one of ordinary skill in the art.

The system 10 and inventive method may apply NMF to process textual information of the input audio tracks 30 to identify or name individual tracks or groups of tracks contained within the input audio tracks 30, extract a song name contained within at least one audio track of the input audio tracks 30 and/or classify a video track associated with or corresponding to at least one audio track of the input audio tracks 30 In general, the inventive method may create a dictionary of relevant terms (with M terms) and create a matrix V in which each column is a document (TV docs), and for each column vy is an occurrence frequency of term i in document j. As a result, V is M×N, and W will then be M×k wherein k is the number of topics to extract, and is the occurrence frequency (or relative relevance) of term i in topic j, whereby H will be k×N, and hᵢⱼ, is the relevance of topic i in document j. Additionally, NMF may be performed with euclidian distance, and sparsity constraints on H.

For example, the system 10 and the inventive method classify video titles of a corresponding video tracks based on one or more extracted song names of an artist. The name of the artist and date of the concert are known a priori and may be used as patterns to initialize W (i.e., M×k). The software, upon execution by the system 10 or the inventive method, may create a list of video titles, and a list of songs (i.e., setlist if known, or all songs from the artist if not known) and the video titles, build the dictionary on the list of songs, and create matrix V from list of video titles: for video i and word with index w in dictionary, V(w, i)=nb_occurences of w in title i. Then, V(:,i) is normalized title-wise (sum of frequencies for 1 title=1). The software may further initialize W with the patterns: artist name, venue name, tour name, and 1 pattern for each song, add one or more trash patterns, for example, ten trash patterns, wherein the one or more trash patterns are initialized randomly, but if a word appears in any non-trash pattern, then its score is set to zero in trash patterns to avoid interferences. Then, W is normalized pattern-wise (sum of frequencies for 1 pattern=1). Still further, the software may further execute, perform or run a NMF on matrix V with (a) euclidian distance, (b) sparsity on H, (c) W initialized as described above, and (d) only the trash patterns of W may be updated by the NMF. Moreover, the computer algorithm or software may further receive, obtain, compute and/or calculate results which may include, for each title, a high score in the song patterns of one of the audio tracks of the input audio tracks 30 indicating that the song name is contained in the corresponding video track. However, if all scores are 0, no song pattern has been extracted from the input audio tracks 30. The score to consider is the score of the pattern (i.e., song name) divided by the number of words in the pattern, otherwise, a pattern of three words which are all activated in the song title or name will get a score three times superior to another pattern of one word also activated in the song title or name.

Often a tour of an artist may be named after the album of the artist or the main song name of the album. To avoid classifying all videos containing the tour name as the song name, the present system 10 and/or method identify first if one of the song pattern is included in the tour pattern. In post-process, if the song is selected for a title, the present system 10 and/or method compare the score of the song to TR× score of the tour pattern, normalized by the number of words of each pattern that are in the video title which may adjust for songs that have complicated titles. If the score of the song is bigger than TR, then the classification is correct, otherwise it is just an artifact of the tour pattern. In embodiments, TR may be about 0.5.

In embodiments, only one word of a pattern is in the video name, but is alone and does not, in fact, intend to represent the pattern. In post-process, a minimum number of words for each pattern may be defined with subsequent checking if the proposed song pattern has more words than this minimum value that appears in the video title. For example, 1 if pattern is of size 1 or 2, and 2 if pattern is longer, may be sufficient.

When working on extracting all songs that are in the list of titles, it may be beneficial to check that a song is indeed existing by checking that at least 1 title categorized as this song contains the whole pattern. If a song is never fully present in a title, it is highly likely that it may, in fact, be a false detection.

Some video titles contain more than 1 song pattern which is also known as multi-song handings. To get useful information, for each title, the system 10 or inventive method may extract all the song patterns that have a score>MR× biggest song pattern score. The NMF may provide good or better scores to well-recognized patterns and poor or very poor scores to lesser-recognized patterns, which is sufficient. For example, MR=0.7 may be sufficient.

The results achieved or obtained from said approach are successful as shown in Table 1. It should be noted the numbers set forth in the second column from the left represent the number of song patterns that were used (i.e., list of known songs of the artist). For example, when the list of possible songs is short (i.e., the setlist of the concert is known), classification may be correct at more than 96% on every tested set of videos titles, and when the setlist is not known and the system 10 is fed the entire list of known songs from the artist, the results may be still over 90%. In the first case, all patterns in the setlist are considered existing, while in the second case the existence of the pattern is verified after classification.

TABLE 1
title extraction results

| Artist | | Correct | Multi-pattern |
|---|---|---|---|
| # | | classification | detection |
| Artist 1 | setlist | 732/750 (97.66%) | 15/19, 4/19, 0/19, 0/19, 5 |
| | no setlist (72) | 716/750 (95.5%) | 15/19, 4/19, 0/19, 0/19, 11 |
| Artist 2 | setlist | 70/70 (100%) | 1/1, 0/1, 0/1, 0/1, 0 |
| | no setlist | 63/70 (90%) | 0/1, 1/1, 0/1, 0/1, 0 |
| | (148) | | |
| Artist 3 | setlist | 80/80 (100%) | 0/0, 0/0, 0/0, 0/0, 0 |
| | no setlist | 78/80 (97.5%) | 0/0, 0/0, 0/0, 0./0, 4 |
| | (182) | | |
| Artist 4 | setlist | 59/61 (96.7%) | 0/0, 0/0, 0/0, 0/0, 0 |
| | no setlist (90) | 57/61 (93%) | 0/0, 0/0, 0/0, 0/0, 0 |

Multi-pattern: all patterns correct, only some detected, too much detected, none detected, # of false positives. The missing ones are those which have been correctly labeled but not detected as multi-pattern (i.e., but are multi-pattern).

However, detecting stop words and meaningful words may actually worsen or lessen the results, as video titles and song titles may not be good examples of proper or correct uses of the English language. Using stop words usually increases the error rate and can sometimes double it. Stemming (i.e., reducing words to their root) may cause a marginal, negative impact by augmenting the number of files that may be classified when they should not be.

In embodiments, the system 10 or the inventive method may, upon execution of the software, verify the setlist of one or more audio tracks of the input audio tracks 30. Let T be a timeline made of videos vᵢ (tᵢ, lᵢ. [p_{{i1}} . . . p_{{in}}], tᵢ, lᵢ) starting at tᵢ of length /ᵢ and classified under the patterns pa to p_{{i1}} to p_{{in}}. T may be the result of an audio-synch algorithm, and/or may be sorted by start times. Let S be the known and ordered setlist of the concert, S=[p₁ . . . p_{N}]. Thus, the problem may be to find the longest, ordered subset of T that enforces the given setlist S:

$$find max \vert {T}^{′} \vert such that \{ \begin{matrix}{T}^{′} & - \{ \{ {v}_{1}^{′} , … , {v}_{{T}^{′}}^{′} \} ∈ \{ {v}_{1} , … , {v}_{T} \} \} \\ ∀ i > 1 & {t}_{i}^{′} > {t}_{i - 1}^{′} \\ ∃ {k}_{1} … {k}_{N - 1} & / {v}_{1}^{′} … {v}_{{k}_{1}}^{′} ∈ {p}_{1} , {v}_{{k}_{1} + 1}^{′} … {v}_{{k}_{2}}^{′} ∈ {p}_{2} , … , {v}_{{k}_{N - 1} + 1}^{′} … {v}_{{T}^{′}}^{′} ∈ {p}_{N} \end{matrix}$$

One goal may be to determine if the timeline may contain errors, and how to detect and remove any detected errors. However, both the setlist and the classification may be typically correct. The software executed by the system 10 and the inventive method to solve said problem, with V being the set of videos to order, may be as follows:

```
create all possible ascending group from V
groups − { }
for i−1:length(V)
  for all group in groups
    if start_time(V(i)) > start_time(group(end))
      group − [group , V(i)]
  end
  if V(i) has not been inserted in any group
    extract subgroup of maximum length from any existing group
          s.t. start_time(subgroup(end)) < start_time(V(i))
    groups − {groups, [max_subgroup, V(i)]}
```

After execution of the software, a resulting group may be sorted by pattern from matrix V and sorted by start_time by construction with the longest created group as corrected timeline T′.

With respect to group order for each same event, the audio-synch algorithm may generate several groups of synchronized audio and video tracks. As a result, the entire same event may be recreated if the setlist is known by sorting said groups. The audio-synch algorithm may be as follows:
For each group, extract a timeline consistent with the known setlist, and extract the corresponding partial setlist (which only contains songs with at least one vid categorized on it)
reorder the partial setlist according to the complete setlist: if partial setlists are in conflict (i.e. contain the at least one common song, or ∃(s₁¹, s₂¹, s₁²)/s₁¹<s₁²<s₂¹ in S), then the corresponding groups are discarded and should be resynched (merged in one group is there is a common song, or split in multiple groups in the second case).

A problem with setlist extraction may arise when no known setlist may be available. Thus, the system 10 and the inventive method are configured or adapted to extract both an accurate and good setlist from the input audio tracks 30 and a consistent sub-timeline of the input audio tracks 30.

For this problem, it may be assumed that the entire list of songs from the artist are known and that this list of songs may be used to classify the video titles, and that this classification may be correct.

In embodiments, the system 10 or the inventive method may, upon execution of the software, solve the following problem to achieve extraction of the accurate setlist and the consistent sub-timeline:
Let T be a timeline made of vids e₁(t₁, l₂, [pᵢ₁ . . . pₘ]) starting at t₁, of length l₁ and classified under the patterns pᵢ₁ to pₘ. T is the result of the audio-synch algorithm, and is sorted by start times.
   Let Eₛ be a set of patterns that are known to be in the setlist Eₛ={p₁, p₂, . . . p_{N}/∀k, ∃t, t₁⊂pₖ}.
   The problem is to find the longest, ordered subset of T and the corresponding ordered subset Sₘ of Eₛ:

$$find max \vert {T}^{′} \vert such that \{ \begin{matrix}{T}^{′} & = \{ \{ {v}_{1}^{′} , … , {v}_{{T}^{′}}^{′} \} ∈ \{ {v}_{1} , … , {v}_{T} \} \} \\ {S}_{m} & = [ {p}_{1}^{m} {p}_{2}^{m} … {p}_{N}^{m} ] ∈ {E}_{S}^{N} \\ ∀ i > 1 & {t}_{i}^{′} > {t}_{i - 1}^{′} \\ ∃ {k}_{1} … {k}_{N - 1} & / {v}_{1}^{′} … {v}_{{k}_{1}}^{′} ∈ {p}_{1} , {v}_{{k}_{1} + 1}^{′} … {v}_{{k}_{2}}^{′} ∈ {p}_{2} , … , {v}_{{k}_{N - 1} + 1}^{′} … {v}_{{T}^{′}}^{′} ∈ {p}_{N}\end{matrix}$$

Once again the goal is to find and remove errors in the timeline, while the classification is considered correct.

In order to solve the above-identified problem, several computer algorithms have been tested. Some of the algorithms may use heuristics while others explore all the possibilities, and some may be based on the order of T while others may be time-based.

For example, the most probable group order algorithm may be based on the setlist verification algorithm and postulates that the most obvious setlist may probably be a good approximation of the real setlist and may be taken as a base to work on. The steps of the most probable group order algorithm may be as follows:

For each pattern in Eₛ, calculate the earliest start time, and sort the patterns by increasing start time;

Use this first order as a base for the setlist verification algorithm, and calculate the longest group possible;

Are there one or several contiguous songs that should not be there (because, for example, the start time is wrong)?

For nb_excluded_pattern=1 to 3, for speed purposes, assumptions may be made that no more than 3 contiguous patterns are errors. For all possible starting indexes, exclude the songs from the base setlist, and generate the new longest group. If the new longest group is longer than the current longest group, keep the new setlist and longest group.

Finally, the order of the patterns in a same video may not be known. While most titles only contain one pattern, those with multiple patterns can indicate that multiple orders may be possible.

For all multi-pattern songs:

For all pairs of patterns for a song, switch the patterns in the setlist, generate best group, try excluding 1-3 songs, generate the according best groups, and keep the overall best setlist and groups

The most probable group order algorithm may be substantially reliable and/or fast, but there may be no guarantee that the final setlist will indeed be the established one, especially for very long setlists.

For time-based tree algorithm, the idea may be to cut the timeline into N chunks, and to find which pattern may be the good one on each chunk. Recursively:

If all choices have been made (at chunk N+1), generate longest group possible with the created setlist and return its length and the current complete choices;

At chunk k, list all possible patterns (i.e. patterns which may have videos running during chunk k). For all possible pattern, choose it and recursively call on the next chunk with the list of current choices. Once all possible paths may have been explored, return the longest group length obtained and the complete choices associated to it. Only the patterns that have not been chose previously may be chosen at chunk k, the only exception being the pattern “running” (i.e. the choice of the chunk k−1), which may still be running. This may ensure that once a song is finished in time, it may not appear again later.

The time-based tree algorithm may have an advantage of exploring all possible possibilities, but may depend on how the chunks are calculated, and the smaller the chunks (i.e. higher granularity), the higher the precision to get the right setlist, but the higher the complexity and the running time.

Two possible choices may be, for example:

cut in same-length chunks (i.e., 30 seconds to 3 minutes, the parameter may be chosen);

try to cut more intelligently, by cutting where the start of songs is the most likely to be, generally, each video start and end times brings a penalty on a window of time around it, penalty that is max in the exact time of start/end. Each contribution may be summed to the others. In the end, the peaks in penalties may indicate where to cut. To avoid having too much cut, a minimum length of a song, like, for example, about 100 seconds may be defined, such that a sliding window in which only one cut can be found may be defined. However, this method may not be exact either.

Moreover, the time-based tree algorithm may be highly dependent on branching factor. Therefore, the more possibilities there are at each chunk, the longer it may take to try every possibility.

For the time-based heuristic tree algorithm, the idea may be to have the same tree walking, but accelerating it by using heuristics such that at each chunk, the choice with the highest number of videos may be the most likely.

For this, at each chunk, rate the possible choices by the number of videos related to each in this chunk, and start by the 2 highest scores. If the longest group from the second is smaller than the longest group from the first, then stop and return the results associated to the first. Otherwise, look at the results from the third and if the group of the second is longer than the group of the third, return the results from the second. Finally, when choosing the good path to return, if both paths have the same number of videos associated, choose the path with the biggest number of different patterns.

The time-based heuristic tree algorithm may be faster than other algorithms, but may not explore all possibilities and may be less sensible to branching factor while sensibility to how the time chunks are cut may be the same.

Time-based accelerated tree may be the same or substantially the same as the time-based accelerated tree set forth above, but is accelerated and may detect when the choice at chunk k does not impact the next possible choices, by pre-calculating these choices and looking for similarities. Said algorithm is then, at chunk k; calculate results associated to each not already calculated choices, then generalize these results to choices with similar future. Finally, when choosing the good path to return, if more than one path may have the same biggest number of videos associated, choose the path with the biggest number of different patterns.

The time-based accelerated tree algorithm may be faster than the original time-based tee algorithm, and may try every possible path.

Time-based heuristic accelerated tree algorithm combines both accelerating techniques. Said algorithm is then: at chunk k, rank all possible choices, calculate results associated to a first rank choice, generalize them to choices with similar future, then if needed do the same for results of a second rank, and generalize them as well, then if the best group from the first rank is higher than the best group from second rank, return results associated to the first rank otherwise generate results associated to a third rank if not already done. Finally, when choosing the good path to return, if more than one path has the same biggest number of videos associated, choose the path with the biggest number of different patterns.

The time-based heuristic accelerated tree algorithm may be the fastest tree walk algorithm presented herein, but may have the same or similar pros/cons as the heuristic algorithm.

For time-based linear programming, the idea may be to optimize the number of videos taken in the timeline based on a choice of pattern at each chunk, with the constraint that each pattern must in one chunk or several contiguous chunks (i.e., at one place only in the same event). Thus, the problem to be solved may be similar to the problem to be solved in the tree algorithms, but linear programming may be utilized to optimize it as a whole. A model of the problem is as follows:
Main variables; N_{y} binary variables (x₁ . . . x_{Ny}) such that x₁=1 if v₁ is in the final timeline, 0 otherwise
   First slack variables: e_{c} (t, p) represent the links between the files associated to pattern p in chunk t: if the pattern has been selected, then all the vids associated to it in this chunk must be activated. Also only one pattern can be selected by chunk, and each pattern should be selected at least once on the whole concert (since we are sure that it exists)
   Second slack variables: eⱼ (t, p)=|e_{c}(t+1, p)−eₑ(t, p)| represents the jumps from and to a given pattern between chunk t and chunk t+1. Since all songs must be selected, the sum on t for a given p must be 2. For this, we create two false chunks, “before 1” (t=0) and “after the end” (t=Inf) to take into account the selection of the first pattern and the de-selection of the last one. Finally, for each chunk, there is at most 2 jumps (one “from”, one “to”).
      with N chunks and P active patterns, we thus have (N+2)*P binary e_{c} variables and (N+1)*P binary eⱼ variables. The constraints are:

$$\{ \begin{matrix}∀ t , p , ∀ i , & {v}_{i} ∈ chunk \{ t , p \} ⇒ {x}_{i} \geq {c}_{c} ( t , p ) \\ ∀ t ∈ [ 1 \text{:} N ] & {\sum }_{p} {c}_{c} ( t , p ) = 1 \\ t = 0 \vert \vert t = Inf & {\sum }_{p} {c}_{c} ( t , p ) = 0 \\ ∀ p & {\sum }_{t} {c}_{c} ( t , p ) \geq 1 \\ ∀ p , t ∈ [ 0 , N ] & {c}_{j} ( t , p ) \geq ( {c}_{c} ( t + 1 , p ) - {c}_{c} ( t , p ) ) \\ ∀ p , t ∈ [ 0 , N ] & {c}_{j} ( t , p ) \geq - ( {c}_{c} ( t + 1 , p ) - {c}_{c} ( t , p ) ) \\ ∀ p & {\sum }_{t} {c}_{j} ( t , p ) = 2 \\ ∀ t & {\sum }_{p} {c}_{j} ( t , p ) \leq 2\end{matrix}$$

With X the concatenation of all the variables, we build the matrices A and A_{eq} and vectors b and b_{eq} such that AX≦b and A_{eq}X=b_{eq}, and define the objective function f as −1 for the first N_{V} elements (we want to maximize the sum but the linear solver is a minimizer), then 0 for the slack variables elements e_{c}, and finally 1 for the remaining slack elements, because we want to limit the number of jumps.

The solution of the time-based linear programming algorithm may be exact if possible, but problems may exist that the number of variables tends to become too large too quickly, making the solver too long to work out the problem, and it depends on how the chunks are made.

The time-based Viterbi algorithm may aim at finding the most probable set of songs based on observations (i.e., the digital videos) by calculating the most probable path on an underlying Hidden-Markov-Model (HMM). The problems of this approach may be: depends on how the time is cut in chunk; depends highly on the model: one must feed the system with probabilities of transitions from a state (i.e., song) to the other (which can be modeled as uniform) and probabilities of observing a video from a given state, which is highly dependent on the unknown error probability of the audio-synch algorithm; and does not offer the possibility to implement the constraint “one song can only be at contiguous chunks”.

In embodiments, the input audio tracks 30 may comprise at least one sample digital multimedia file (hereinafter “sample”) which may include both digital audio and video files. In an embodiment, the sample may be uploaded, stored and/or accessible via a website. The sample may be used, in its entirety or only in part, along with one or more samples, to form a group of digital multimedia files (hereinafter “group”). In embodiments, the system 10 and/or the inventive methods regroup several samples to form a multi-angle video file of a part or one or more portions of the same event. In an embodiment, the same event may be a concert containing one or more musical artist and/or musical group (hereinafter “artist”) that may be part of the same event or performance that may have occurred on the same day, at the same venue, played by the same musical artist and/or musical group.

In embodiments, the multi-angle video file may contain a single song, not a whole concert. Therefore in some cases, the system 10 and/or the inventive methods are configured and/or adapted to tag each group of samples with a song name, and not to find the ordered setlist for this group of samples. The processing of each new concert may be completely independent from other concerts by the same artist. In some embodiments, one or more tour names may be detected as a song name in the samples. Moreover, as it is known some artists choose the name of their latest album or song as the name of their tour. When one or more users upload samples onto a website which may store the samples in the database 24, the one or more users sometimes mention the name of the tour, which is detected as a song name in the samples by text algorithms.

Therefore, it is an objection of the present system 10 and/or the inventive methods to label every group of samples with one or more song names. The groups of samples may contain a single song or one or more songs. In an embodiment, the software described herein may utilize information gathered for an artist to label every group of samples. The information may include one or more of the following: one or more setlists of concerts of the artist; one or more studio recordings of songs along with the song names of the songs for the artist; one or more audio and video files recorded from concerts that were previously generated on our website; and/or identification information of the samples used to generate the groups of samples, along with the video titles.

Utilizing some or all of the information, the present system 10 and/or the inventive methods label groups of samples as soon as a concert may be generated. The present system 10 and/or the inventive methods maintain a database (i.e., database 24) which may contain some or all necessary input, such as, for example, one or more setlists, one or more audio fingerprints, and metadata (i.e., titles) for relevant samples of the groups. As a result the present system 10 and/or the inventive methods improve results by reprocessing all the data from a given artist and/or improve tagging for concerts that were generated when less data was available for the artist. In an embodiment, the input audio tracks 30 comprises the some or all necessary input.

In embodiments, the present system 10 and/or the inventive methods are adapted and/or configured for setlist extraction and/or extracting song names from one or more of the samples. The software may comprise one or more algorithms for string matching and/or the present system 10 and/or inventive methods may utilize at least one dynamic programming approach for finding, identify, determine and/or calculate the longest common subsequence (hereinafter “LCS”). The present system 10 and/or the inventive methods may comprise audio matching and database searching (hereinafter “ADS”) method to find similarities between audio tracks or samples by the same artist, whereby these audio tracks or samples may be live performances or studio recordings. The ADS method may utilize, for an audio query, a first algorithm that may ranks the audio files or samples in the database in order of likelihood to match the audio query. The ADS method may utilize a second algorithm that may “fine matches” the audio query with each file or sample from the database, in descending likelihood order. The second algorithm may stops, end or terminate when the second algorithm finds a match, or when a given maximum number of files may have been tested.

In embodiments, the present system 10 and/or the inventive methods are configured and/or adapted to cluster all live performances and studio recordings of the same song together via spectral clustering. Alternatively, the cluster may be achievable by Markov Cluster Algorithm which may produce similar clustering results.

To accomplish the clustering, the software comprise one or more of the following algorithms: text algorithms that may match video titles with song names; audio algorithms that may match sample or group audio tracks with other groups of samples, or with studio recordings by the artist; and fusion algorithms that merge all matches from previous algorithms into a single output. As a result, the software may tag each group with one or more songs

The text algorithm of the software may find which song(s) appears in each group of samples. For this, the software may utilize the title of the samples used during the generation of each group. The software may rely on one or more of the three steps: normalization of all strings to simplify the matching process and make the software more robust; a LCS algorithm, to match titles with song names; and weighting of the results, to make the software more robust to common errors.

As input, the software may only require the groups for one concert, as well as the song list for the artist. However, the software may not require data from previous generated concerts. Therefore, the software may process a single new concert, or the entire dataset of an artist without any difference.

For title normalization, song and video titles can contain special characters, be in various languages, etc. To normalize the title, the present system 10 and/or the inventive methods utilize a Python library unidecode, which may convert a Unicode/UTF-8 string back to a sequence of ASCII characters. The titles may be converted to lower case. A special treatment may be performed for the ampersand character, which may be transformed into, for example, “and”. All non-alphanumeric characters may be removed, including white spaces. As a result of said preprocessing, one or more of the following problems are address: spelling mistakes; missing white spaces; and use of special characters as ornament in video titles. Examples of string normalization are shown in Table 2. To be able to match video titles with song names, all strings are preprocessed in the same, substantially the same or similar way.

TABLE 2
Examples of string normalization
LADY GAGA LIVE KÖLN LANXESS ARENA artRave TOUR 07.10.2014(HD) - VENUS
ladygagalivekolnlanxessarenaartravetour07102014hdvenus
Lady Gaga - “You & I” Live Stade de France, Paris - France 22/09/2012
ladygagayouandilivestadedefranceparisfrance22092012

Because of spelling mistakes and typos, simply looking for exact song names in video titles would decrease performances of the software. Instead, the software comprises the LCS algorithm which may compare each video title with each song name known for an artist. Video and song titles are very short strings, compared to whole documents; therefore, testing all song names against each video may still be very fast and efficient. For this method, the software may only try to match known song names and the name of the artist, the name of the venue, or the date of the concert may not be needed. If the name of the tour is the name of a song, it will be detected as a match.

To avoid short song names matching with long video titles, a penalty in the LCS algorithm may be introduced. Given two sequences {aᵢ}_{i∈1 . . . M} and {bⱼ}_{j∈1 . . . N}, respectively of length M and N, the (M+1)×(N+1) LCS table {Ci,j}_{i∈0 . . . M,j∈0 . . . N} is defined by:

$${C}_{i , j} = \{ \begin{matrix}{C}_{i - 1 , j - 1} + 1 & if {a}_{i} = {b}_{j} \\ max ( 0 , max ( {C}_{i , j - 1} , {C}_{i - 1 , j} ) - p ) & otherwise\end{matrix} ∀ i ∈ 1 … M , j ∈ 1 … N$$

where C_{0,j}=C_{i,0} ∀i, j and p is the penalty of having two non-matching characters. In embodiments, p=0.25.

Finally, we decide whether a video title v and a song s match (M_{v,s}=1) by thresholding the output of the LCS algorithm LCS_{v,s}=max_{i,j} (Ci,j):

$${ℳ}_{v , s} = \{ \begin{matrix}1 & if ( {L}_{s} \leq 4 {LCS}_{v , s} = {L}_{s} ) ( {L}_{s} > 4 {LCS}_{v , s} \geq ρ {L}_{s} ) \\ 0 & otherwise\end{matrix}$$

where Lₛ the length (in characters) of song s, and ρ∈(0, 1] is a ratio used to tolerate spelling mistakes, the lower the more tolerant. In embodiments, ρ=0.8. When Lₛ≦4, the software may be only looking for an exact match, as tolerating spelling mistakes would produce too many false positives. At the end of this step, for each video v, a list of songs Sᵥ={s|M_{v,s}=1} is provided that should appear in the video. In this list of matches, false positive may occur when the name of the tour, mentioned in the video title, is also the name of a song.

For match weighting, one group g may composed of a set of several videos or samples, V_{g}={vk}. The more a song may be mentioned in video titles of the samples, the more likely it is that group g may actually contain this song. If a user recorded several songs in a row, or compiled different parts of the concert in a single video, it is likely that the user will mention all of them in the video title. The appearances of the songs Sᵥ over all the videos in V_{g} may be averaged to find the most likely song(s) in group g. As a result, this match weighting alone may perform very well in most cases.

However, the aforementioned case of tour names being song titles causes some trouble. To solve this problem, the present systems 10 and/or inventive methods may make an assumption on the efficiency of the audio algorithm that may be utilized to synchronize videos or samples into groups. If two videos v1 and v2 contain the same performance of a song s, the two videos v1 and v2 should be grouped in the same group g by utilizing audio synchronization methods. Therefore, for a given concert c, only one of its groups g∈G_{c} should contain song s. The present system 10 and/or inventive methods may weigh the songs before assigning the two songs to groups. Let S_{g} be the set of songs contained in at least one of the videos v of group g:

$${S}_{g} = {⋃}_{v ∈ {V}_{g}} {S}_{v}$$

For a given concert c, each song has a weight ωₛ^{c}:

$${w}_{s}^{c} = \frac{1}{{\sum }_{g ∈ {G}_{c}} {1}_{{S}_{g}} ( s )}$$

where [symbol] _{A}(x) is the indicator function of a subset A. Therefore, the more a song appears in different groups from the same concert, the less weight it has, because it is not possible for the song to be part of all groups at the same time. By simply gathering the matches for each sample used in a group, a new estimate ηₛ^{g} is obtained defining the likelihood of a song s appearing in group g of concert c:

$${η}_{s}^{g} = {( \frac{1}{{Z}_{g}} {w}_{s}^{c} \times {\sum }_{v ∈ {V}_{g}} {1}_{{S}_{v}} ( s ) )}^{α}$$

Z_{g} is a normalization factor such that the most likely song has [symbol] =1. α is a heuristic to give more weight to songs that are more likely. In embodiments, α=2. A group may often contain a single song; therefore, the present system 10 and/or inventive methods may only keep the first result for display on, for example, a website. However, a more detailed result may be obtained by thresholding the values of ηₛ^{g}, or by looking at intermediate results.

In embodiments, given an audio query g (the audio track of a group), a likelihood value l_{g,g0} for each audio entry ǵ in a database (the rest of the groups, from other concerts, by this artist) is obtainable. A high value may indicate a high likelihood of the two tracks g and ǵ containing the same song (but potentially different performances of the song). Because groups from the same concert cannot match (otherwise the groups would have been merged during an audio synchronization step), their likelihood is 0: l_{g,g0}=0 if g∈G_{c} and ǵ∈G_{c}. Likelihood values may be normalized such that 1% of the values are above 1 for a given query, i.e. normalize by the first percentile.

Two audio tracks are considered a match when l_{g,g0}≧l_{match}. In embodiments, l_{match}=1.3. If several groups ǵ are over this threshold, the several groups g′ may be ranked in decreasing order, and/or may be weighted according to their rank, without reusing the likelihood values:

$${μ}_{g , {g}^{′}} = \{ \begin{matrix}\frac{1}{{Z}_{g}^{′}} \times \frac{1}{r} & if {l}_{g , {g}^{′}} \geq {l}_{match} \\ 0 & otherwise\end{matrix}$$

with r the rank of ǵ in decreasing order of likelihoods: r=Σₕ [symbol] (l_{g,h}≧l_{g,g′}), and Z′_{g} a normalization factor such that Σₕμ_{g,h}=1.

For fusion and/or labelling algorithms, the software may combine the results of matching groups with song names into a single output. As a result, the most or more accurate list of songs for each group may be produced. The software may utilize a global approach by applying (spectral) graph clustering to all video groups by the same artist. As a result, clusters may each represent one song. The software may utilize an approach that propagates the previously computed weights from the text and audio algorithms.

In embodiments, graph clustering is a wide field composed of many different techniques. The software may utilize spectral clustering, based on the adjacency matrix of a graph. The first step may be to construct the adjacency matrix A and create a graph for a given artist where each node is a group. In addition to these group-nodes, one song-node for each song name may be defined. A group-node is defined by its audio track and its sample titles, as opposed to a song-node, which is simply the name of the song. A song-node may be seen as an audio track too, wherein the studio recording was obtained.

An edge between two nodes can come from either the text or audio algorithm. The text algorithm defines edges between group-nodes and song-nodes: A_{g,s}=A_{s,g}=η^{g}ₛ. The audio algorithm creates links between group-nodes: A_{g,g′}=μ_{g,g′}.

It may be noted that links between groups are not necessarily symmetric, i.e. in the general case μ_{g,g′≠μ}_{g′,g}. However, it may not make sense to keep this asymmetry (if a group matches another, the link may go both ways). The adjacency sub-matrix for group nodes may be made symmetric and normalized (the edges to the song-nodes are already symmetric and normalized):

$${A}_{g , {g}^{′}} = {A}_{{g}^{′} , g} ← max ( {A}_{g , {g}^{′}} , {A}_{{g}^{′} , g} ) ∀ g , {g}^{′} ∈ group \text{-} nodes$$

$${A}_{g , {g}^{′}} ← \frac{{A}_{g , {g}^{′}}}{{max}_{( g , {g}^{′} ) ∈ groups - {nodes}^{2}} ( {A}_{g , {g}^{′}} )}$$

An extra step may be to remove all song-nodes that are not connected to any other nodes. Once the adjacency matrix A is set, the goal is to find a set of clusters, hoping that each one will group a single song-node with one or several group-nodes. There are several variations of spectral clustering, the present system 10 and/or the inventive methods may utilize one based on the normalized Laplacian matrix L:

L=I−D^{-1/2}AD^{-1/2}

where I is the identity matrix and D is a diagonal matrix:

$${D}_{i , j} = \{ \begin{matrix}{\sum }_{k} {A}_{i , k} & if i = j \\ 0 & otherwise\end{matrix}$$

A next step may be to compute the first N_{vec} eigenvectors eᵢ of L, in terms of smallest eigenvalues λᵢ. Then, the software may apply the standard K-mans algorithm on E=[e₁ . . . e_{Nvec}], treating rows of E as observations. In embodiments, the software may look for as many clusters as song-nodes kept in the graph.

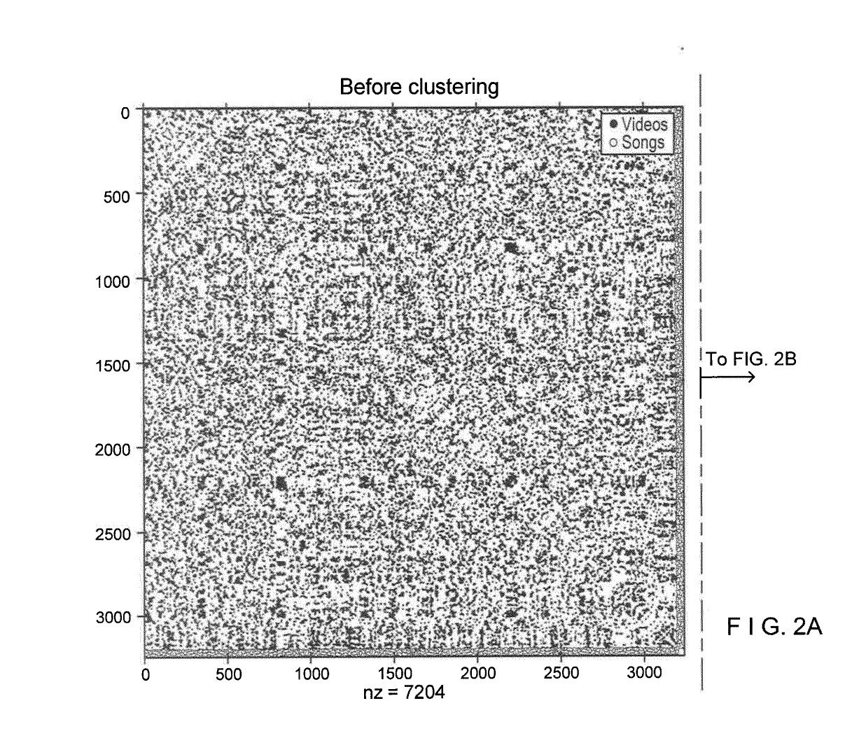

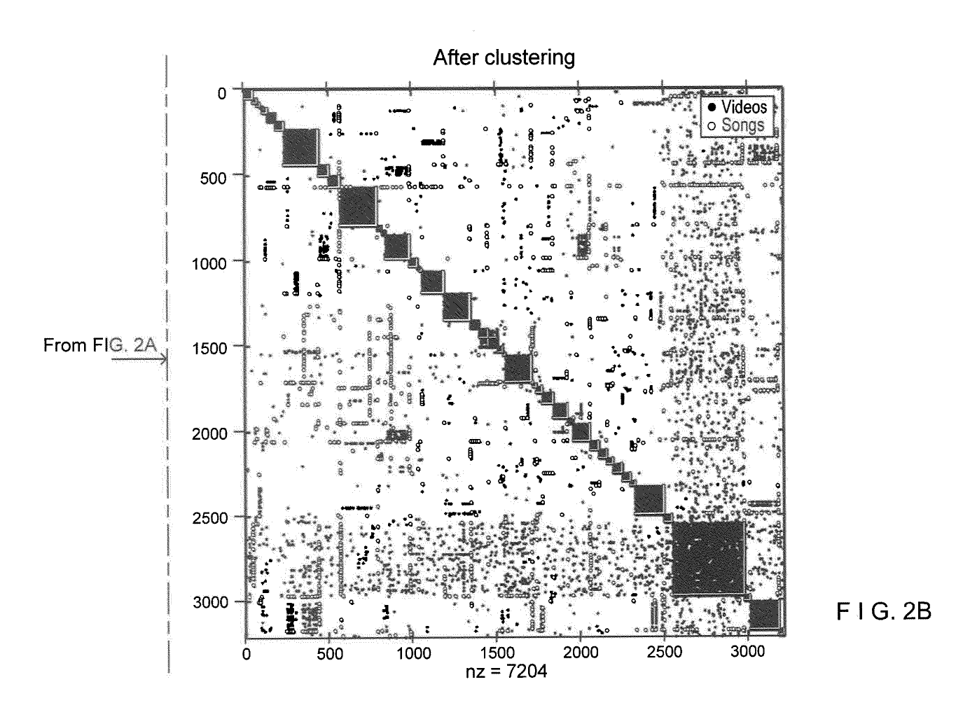

FIGS. 2A and 2B show the results of graph clustering on the dataset for an artist. Once the groups are clustered, it can be clearly seen that different songs are within the dataset (see FIG. 2B). Further, FIG. 2B shows the results for the graph clustering algorithm on the dataset, on 3170 groups. Blue dots are non-zero edges between group-nodes, red dots are non-zero edges between a group-node and a song-node. The graph on the left-hand side shows nodes in a random order before clustering and the graph on the right-side shows nodes are ordered by cluster.

Even though results were encouraging, efforts were not pursued further as there may be still a considerable post-processing step to perform. A way to find song names is to assign all song names (from song-nodes) to all groups in the same cluster. However, this may create a lot of false positives and other errors. Also, it may be noted that this method is effective for large datasets, but may not give good or similar results for smaller ones, when there are fewer edges between group-nodes.

In embodiments, the present system 10 and/or inventive methods may be utilized in production to tag new concerts which may be referred to as “online labelling”. The present online labelling may find song titles for a new concert without having to reprocess the whole artist. The present system 10 and/or inventive methods may find new song names from the setlist of a freshly generated concert, as well as reprocess all set lists from an artist to find a more accurate and/or coherent song list. Further, the present system 10 and/or inventive methods may label a new concert by utilizing the weights computed by both the text and the audio algorithms. Still further, the present system 10 and/or inventive methods may utilize the same algorithm to reprocess the entire dataset of an artist.

In embodiments, the present system 10 and/or inventive methods are configured and/or adapted to obtain a setlist for each new concert that is being processed. Each new concert may contain one or more new song names that need to be added to the song list of the artist. As mentioned above with respect to the text algorithm, the song names from the setlist are normalized in the same or similar way as the samples are normalized. When processing a single new concert, the software may look for exact matches between the existing artist's list and the new setlist. If a match cannot be identified, the present system 10 and/or inventive methods may add the new song to the artist's list. This approach is justified by the need for consistency with already processed concerts: changing a song from the existing list would potentially invalidate matches from previous concerts.

The approach is slightly different when reprocessing all the groups from an artist because the software rewrites all matches for all groups anyway. In this case, all setlists from all concerts may be used at once to produce the artist's song list. Further, the present system 10 and/or the inventive methods may normalize all the titles, and remove extra occurrences of normalized songs that appear more than once. Another step that was proved useful is to remove songs that are composed of another song title and a suffix. In some setlists, the type of performance is mentioned, e.g. “Song Name 1 (Acoustic)” or “Song Name 1 (Piano & Voice)”. This is undesirable as the software may only want and/or need the name of the song. This is also true for track lists from records, e.g. “Song Name 1 (Radio Edit)”. Table 3 gives an example of output when using this additional step.

TABLE 2
Example of a song list extracted from several setlists

| Original setlists (aggregate) | Normalized songs kept | Original title |
|---|---|---|
| Just Dance | bornthisway | Born This Way |
| Ratchet [Interlude] | justdance | Just Dance |
| Born This Wav | ratchet | Ratchet |
| Born This Way (Acoustic) | | |
| Just Dance/Poker Face/Telephone | | |
| Ratchet | | |

Using a set of already generated groups/concerts from an artist, the present system 10 and/or the inventive methods may apply both the text and audio algorithms to find song names for groups belonging to a new concert that may have just been generated. The text algorithm may be applied, as described above, on the title of each sample independently. The results may then be merged for each group of the new concert. The audio algorithm may be applied to find matches with previously generated groups from the same artist. Songs may be assigned to a group in two ways: directly, using the text algorithm, or by propagating matches from previously generated groups, according to audio matches. This defines a new weight y^{g}ₛ:

$${γ}_{s}^{g} = \frac{1}{{Z}_{g}^{″}} ( {η}_{s}^{g} + {\sum }_{{g}^{′} \neq g} {μ}_{g , {g}^{′}} {γ}_{s}^{{g}^{′}} )$$

that expresses the likelihood of a group g containing a song s. As always, Z″_{g} is a normalization factor such that maxₛγₛ^{g}=1.

The output of the algorithm is simply the list of songs with a non-zero weight: Oₛ={s|γₛ^{g}>0}. The present system 10 and/or the inventive methods may sort them by decreasing weight for clarity and/or may keep only the first result to display on, for example, a website.

Sometimes it may be useful to analyze once again all the groups from an artist. For example, new song names might have become available from new setlists that were not available during the first or previous pass. Also, the audio algorithm may perform better on a larger database. Based on the online labelling as previously discussed, the software may comprise an algorithm to reprocess all groups of an artist. First, the present system 10 and/or inventive methods may utilize all available setlists to find song names. The text and audio algorithms may then run or be executed to compute n^{g}ₛ and μ_{g,g′} for all groups. As a result, the database of the audio algorithm may be composed of all other concerts from the artist (not only the ones that occurred before in time). The online labelling may then be performed on each concert in a random order (no need to follow chronological order of concert generations). This way we obtain new weights y^{g}ₛ. This process may run several times to average the weights over several iterations: y^{g}ₛ, wherein the weights may once again be normalized after averaging, so that the maximum weight for a group may be 1).

In embodiments, the output of the one or more algorithms may be, for each group, a set of songs with non-zero weights y^{g}ₛ, the highest being 1. As a group may contain several songs, an additional step may be required to actually determine how many songs may be in the group, in what order, etc. However, most groups may contain only one song, and only one of song may be displayed via, for example, a website. Therefore, the present systems and/or inventive methods may just showing the first result, i.e. the song for which y^{g}ₛ=1. The additional results may be utilized in decreasing weight order, in case the first song was not the correct title. For groups containing more than one song, the following results in O_{g} are usually the other songs in the group, although not used for display by, for example, the website.

The present system 10 and/or inventive methods may comprise a command-line tool (not shown in the drawings) which was written such that the algorithms of the software may be combinable to one or more label video groups from at least one artist. The command-line tool comprises one or more operating modes selected from an online mode, an offline mode, an addconcerts mode and an addrecordings mode. The online mode may be utilized by the present system 10 and/or inventive methods to label a new concert. The offline mode may be utilized by the present system 10 and/or inventive methods when new data (e.g. setlists) may become available for an artist, which may improve the labelling of all video groups of the artist. The addconcerts mode may be utilized by the present system 10 and/or inventive methods to add several concerts from the same artist at once, without processing them. The offline mode may be utilized by the present system 10 and/or inventive methods after utilization of the addconcerts mode. The addrecordings mode may be utilized by the present system 10 and/or inventive methods to add studio recordings by an artist to the database

In embodiments, the present system 10 and/or inventive methods may comprise and/or utilize the command-line tool, a database, such as, for example, database 24, and/or an application programming interface (hereinafter “API”) which may be associated with and/or accessible by the system 10. The database may store at least one selected from one or more fingerprints of the groups and/or the studio recordings, one or more matches between the one or more fingerprints and the one or more songs from at least one song list of the artist, one or more setlists, metadata for the samples utilized by the one or more groups, and at least one song list for each artist. In an embodiment, the command-line tool may access website API to update one or more song names for one or more groups.

In embodiments, the online mode may be utilized by the present system 10 and/or inventive methods after a new concert has been generated via the present system 10 and/or inventive methods. The online mode is utilized by the present system 10 and/or inventive methods to tag one or more newly generated groups with one or more song names from the artist. While utilizing the online mode, the input 30 utilized by the system 10 and/or inventive methods may include at least one selected from a name/ID of the artist for which a new concert has been generated, a unique ID of the new concert, a setlist for the new concert, if available, a list of groups that were generated, with their corresponding digital audio track and for each group, a list of digital multimedia samples utilized to generate the groups, and metadata of the digital multimedia samples that were utilized in the groups. The output 32 from utilizing the online mode may comprise, for each group, a list of matching song names, along with weights for each matching song name.

While utilizing the online mode, the software may fetch or access all available data for the artist from the database, compare the existing song list from the database for the artist with the setlist of the new concert, add new songs to the song list, apply the text algorithm to input video titles, apply the audio algorithm on groups from the new concert, comparing the groups with the existing audio fingerprints from the database for this artist, apply the online labelling algorithm to new groups, store or save data or information to the database, wherein the data or information includes an updated song list, a setlist, one or more audio fingerprints for the one or more new groups, one or more matches and/or one or more samples, and return the one or more matches for each group.

In embodiments, the offline mode may be utilized by the system 10 and/or inventive methods, optionally at any time, to reprocess all the groups by the artist. The offline mode may be utilized when new data has become available for an artist. As a result, the system 10 and/or inventive methods may tag previously generated groups that could not be tagged. While utilizing the offline mode, the input 30 utilized by the system 10 and/or inventive methods may comprise a name/ID of the artist to reprocess and/or the output may comprise, for all video groups by the artist, a list of matching song names, along with the weights of each matching song name.

While utilizing the offline mode, the software may fetch or access all available data for the artist from the database, produce a list of unique song names for the artist utilizing all, or a portion of, the available setlists, and also studio recordings if available, apply the text algorithm to the video titles for the artist, apply the audio algorithm on all groups of the artist, processing one concert at a time, using all other available concerts as the audio database, simulate online labelling on all concerts, save or store the updated song list and updated matches back via the database, send results for all groups to a website API, and/or return the matches for all groups.

In embodiments, the addconcerts mode may be utilized by the system 10 and/or inventive methods to add one or more concerts to the database in a row, without processing the added one or more concerts. Subsequently, the system 10 and/or inventive methods may utilize the offline mode to label all groups for a given artist at once based on the added one or more concerts. While utilizing the addconcerts mode, the input 30 may comprise at least one selected from at least one name/ID of at least one artist, at least one list of one or more concerts wherein each list comprises at least one unique ID of each concert, at least one setlist for each concert, if available, at least one list of one or more groups belonging to each concert, with corresponding digital audio track and for each group, at least one list of digital multimedia samples used in the groups, and metadata of all samples that were used in the groups.

While utilizing the addconcerts mode, the software may fetch or access all data for the artist from the database, for each group, compute its audio fingerprint via an algorithm, and/or save data and/or information via the database, wherein the data and/or information may comprise one or more setlists, one or more groups, one or more audio fingerprints, one or more digital multimedia samples.

In embodiments, the addrecordings mode may be utilized by the system 10 and/or inventive methods to add one or more studio recordings to the database. While utilizing the addrecordings mode, the system 10 and/or inventive methods may add one or more additional or subsequent song names to the database and/or one or more audio fingerprints for the artist. As a result, the addrecordings mode may improve one or more results of the audio algorithm. The input 30 may comprise at least one name/ID of the at least one artist, at least one list of one or more studio recordings, wherein each list may comprise at least one unique ID, at least one audio track for one or more recordings, and/or at least one name of each recording.

In utilizing the addrecordings mode, the software may fetch or access all available data for the artist from the database, compare the existing song list from the database for the artist with the at least one name of the one or more recordings, wherein the list of record names may be seen as a setlist, add one or more new songs to the existing list, for each studio recording, compute the audio fingerprint of each studio recording via one or more algorithms of the software, and/or save or store data and/or information in the database wherein the data and/or information comprises one or more studio recordings, at least one name of each recording, at least one ID of each recording and/or at least one audio fingerprint of each recording.

In embodiments, no setlist and no studio recording may be available for an artist, and the system 10 and/or inventive methods may be unable to produce a song list. However, there may be data or information in the titles of sample digital multimedia files which may allow the software to extract song names directly from the titles, without requiring any setlist or studio recording. In an embodiment with respect to the text algorithm, one or more users may forget or avoid including “The” in front of song names when there is one (e.g. the user enters “Hell Song” in the video title when the song name is actually “The Hell Song”). The text algorithm may correct this error by removing occurrences of “The” in the song list. A similar error may exist for long song names like “Over My Head (Better Off Dead)”, often shortened by users as “Over My Head”. The text algorithm may remove words or phrases found within parentheses. In an embodiment, the audio algorithm may be a first part of a two-fold algorithm. The second-fold or step may comprise in “fine matching” the query with the first few results (i.e., the likelihood ranking) from the database. Using this second-fold or step may improve the results of the audio algorithm, and hence the weights μ_{g,g′}, which may be fed to the fusion algorithm.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A method for identifying and/or labelling one or more digital multimedia tracks recorded at a same first event performed by a same artist, the method comprising:
accessing sample digital multimedia files that are storable in a database, wherein the sample digital multimedia files are original recorded digital videos that were recorded from multiple digital sources at the same first event, wherein the sample digital multimedia files have metadata comprising video titles associated with the sample digital multimedia files;
matching the video titles of at least a portion of the sample digital multimedia files with at least one song name associated with the same artist to provide one or more first matchings;
matching at least a portion of the sample digital multimedia files with (i) one or more groups of digital audio tracks associated with the same artist or (ii) one or more studio recordings by the same artist to provide one or more second matchings; and
merging the first and second matchings into a single output that is labeled with one or more song names associated with the same artist.

2. The method according to claim 1, wherein the single output comprises a song list of at least a portion of the same first event performed by the same artist.

3. The method according to claim 1, further comprising:
grouping at least a portion of the sample digital multimedia files together to form a multi-angle video of at least a portion of the same event.

4. The method according to claim 1, further comprising:
labelling a group of digital video files recorded at a second event with one or more song names associated with the same artist or one or more different artists.

5. The method according to claim 1, further comprising:
adding new data associated with the same artist to a database as the new data becomes available; and
labelling a group of digital video files associated with the same artist based on the new data.

6. The method according to claim 5, wherein the new data comprises a setlist of the same first event.

7. The method according to claim 1, further comprising:
adding one or more groups of digital video files to a database, wherein the digital video files were recorded a plurality of events performed by the same artist; and
labelling the one or more groups of digital video files with one or more song names associated with the same artist.

8. The method according to claim 1, further comprising:
adding at least one new studio recording by the same artist to a database; and
labelling a group of digital video files based on the at least one new studio recording.

9. The method according to claim 1, wherein the single output comprises a list of matching song names.

10. The method according to claim 1, further comprising:
accessing a website application programming interface to update song names of at least one group of digital video files stored in a database.

11. The method according to claim 1, wherein the second matchings are based on at least one selected from first digital fingerprints of the one or more groups of digital audio tracks associated with the same artist and second digital fingerprints of the one or more studio recordings by the same artist.

12. The method according to claim 1, wherein a text algorithm provides the first matchings and an audio algorithm provides the second matchings.
